(19) United States
(12) Patent Application Publication
(10) Pub. No.: US 2002/0063780 A1
(43) Pub. Date: May 30, 2002

(54) Teleconferencing system

(76) Inventors: Philip Victor Harman, Western Australia (AU); John Otis Merritt, Williamsburg, MA (US)

Correspondence Address: BANNER & WITCOFF, 1001 G STREET N W, SUITE 1100, WASHINGTON, DC, 20001, US

(21) Appl. No.: 09/848,728

(22) Filed: Apr. 30, 2001

(30) Foreign Application Priority Data
Nov. 23, 1998 (AU) PP7275
Nov. 19, 1999 (AU) PCT/AU99/01036

(51) Int. Cl. H04N 7/14

(52) U.S. Cl. 348/211; 348/14.01

(57) ABSTRACT

A local station for a teleconferencing system including a tracking means for locating the eyes and/or head of a local viewer, a projection means adapted to project left and right eyes images from a remote station to respective left and right eyes of the local viewer, an image capture means adapted to capture and transmit left and right eye images of the local viewer to the remote station; wherein the projection means is movable in response to movements of the local viewer and wherein the image capture means is movable in response to control signals from the remote station.

### RELATED APPLICATIONS

This application is a continuation of and claims priority to International Application No. PCT/AU99/01036 filed Nov. 19, 1999 and to Australian Application No. PP 7275 filed Nov. 23, 1998, both of which are herein incorporated by reference.

### FIELD OF THE INVENTION

The present invention is directed towards an improved teleconferencing system and in particular a teleconferencing system that enables the participants to view each other in 3D and to also see a different perspective of each other as their heads are moved. The system also enables the participants to maintain the appearance of eye contact with each other.

### BACKGROUND ART

The use of teleconferencing systems that enable participants at remote locations to both hear and see each other have been used for many years. The cost savings of teleconferencing in comparison to face to face meetings are well understood and this form of communication is used by many organizations and individuals on a daily basis. The advent of the Internet has reduced the cost of international data communications to such an extent that the cost of teleconferencing systems is now within the budget of many people worldwide.

The essential elements of existing teleconferencing systems are:

1. A video display device, usually a PC monitor, TV, or projection video system.

2. A video camera imaging at least one participant in the teleconference.

3. A two way audio system.

4. A transmission medium that enables video and audio to be exchanged between the participants locations.

The most popular, and cheapest, teleconferencing systems are those based around a PC and use the Internet as the data communications medium. Advanced systems may use specially constructed and designed rooms and large screen projection systems.

Whilst such systems are undoubtedly useful, they are not realistic enough to enable the participants to believe that the person they are speaking to may actually be in their presence.

There are a number of physiological factors that are lacking in such teleconferencing systems which detract from the realism of the experience. These factors include:

a. Low resolution images which do not present a lifelike image.

b. Images not to scale. For example, a person's head and shoulders may be dependent on the size of a tv monitor.

c. Transmission delays discernible in the images being viewed, giving rise to erratic movements of the participants.

d. Images are flat and therefore not perceived as being lifelike, in that there is no depth to the viewed image.

e. Images are seen from a single perspective and do not alter as the viewers head is moved.

f. It is not possible for the participants to obtain eye contact.

Whilst factors a, b and c can be overcome with careful construction and system design, existing systems have been unable to satisfactorily address factors d, e and f.

Previous attempts to provide different perspectives of the viewer were achieved by providing a plurality of images of the viewer taken from a plurality of cameras. Each image from one station was projected to the other station. Such displays typically had small screens, provided individual images at low resolution and required additional bandwidth to enable multiple views to be broadcast simultaneously. However, not only did such systems fail to provide realistic perspective views of each party due to the fixed nature of each camera, but extra bandwidth was also required to enable all the images to be transferred.

Existing systems have also been unable to provide the perception of each viewer looking the other in the eye. Due to the positioning of the camera, even if the viewer on a local station was looking directly at the position of the eyes on the screen, the viewer at the remote station would get the impression that the local viewer was staring at some other point and avoiding eye contact.

### OBJECTS OF THE INVENTION

It is therefore the object of the present invention to provide a teleconferencing system that enables each participant to be seen in 3D. It is a further object of the present invention that each party should be able to maintain eye contact with the other, and that as each party moves their head a different perspective of the other party should be obtained as would be the case if the parties were actually in each others presence.

### SUMMARY OF THE INVENTION

With the above objects in mind the present invention provides in one aspect a local station for a teleconferencing system including:

a tracking means for locating the eyes and/or head of a viewer;

the tracking means including an illumination means and a plurality of cameras for imaging the viewer;

wherein said cameras are capable of being moved in x, y and z directions in response to control signals from a remote station.

In a further aspect the present invention provides a local station for a teleconferencing system including:

a tracking means for locating the eyes and/or head of a local viewer,

a projection means adapted to project left and right eyes images from a remote station to respective left and right eyes of the local viewer:

a image capture means adapted to capture and transmit left and right eye images of the local viewer to the remote station,

wherein said projection means is movable in response to movements of the local viewer and wherein said image capture means is movable in response to control signals from the remote station.

Conveniently, the local station would also include a retroreflective screen and a semireflective mirror to enable the images from the remote station to be projected onto the eyes of the viewer, and for the images of the viewer to be sent for viewing at the remote station. Further, the signals from the remote station may correspond to movements of a second viewer at the remote station.

Ideally, the local station includes an audio system including a microphone and a speaker means; wherein the speaker means enables the viewer to hear sound from the remote station, and the microphone is able to transmit sound to the remote station.

Preferably, the tracking system should be able to track movements of the viewer in the x, y and z directions.

It will be understood that a teleconferencing system could include a local station and a remote station, and that the remote station could be identical to the local station. In such a configuration the second camera means from the local station would receive signals from the tracking system of the remote station, and the second camera means from the remote station would receive signals from the tracking system of the local station.

### BRIEF DESCRIPTION OF DRAWINGS

FIG. 1 shows a preferred embodiment of a local station of the present invention

FIG. 2 shows how two stations as illustrated in FIG. 1 can be interconnected to form a teleconferencing system,

FIG. 3 shows how the communications requirements of such an interconnected system can be simplified.

FIG. 4 demonstrates a weakness in the basic embodiment.

FIG. 5 shows one method of addressing the weakness outlined in FIG. 4.

FIG. 6 shows an alternative method to FIG. 5.

FIG. 7 shows an arrangement to eliminate the need for tracking cameras in the x axis.

FIG. 8 shows an arrangement to eliminate the need for tracking projectors in the x axis.

FIG. 9 shows a method for increasing the size of the exit pupil in the y direction to eliminate the need for y axis tracking.

FIG. 10 shows an alternative method of overcoming the weakness identified in FIG. 4.

FIG. 11 shows a method of gating the light from a projector

FIG. 12 shows a method of turning off the light from a projector

FIG. 13 shows an alternative embodiment of the present invention.

### DETAILED DESCRIPTION

The preferred embodiment of the present invention involves the use of an autostereoscopic display incorporating an eye or head tracking system for locating the eyes or head of the viewer and a plurality of cameras imaging the viewer that under servo control can be moved in the x, y and z axis in response to control signals from a remote location. The additional depth information contained in the 3D images assist with the realism of the experience. Whilst a stereoscopic display and suitable headgear can be used, it is preferable that an autostereoscopic display system be utillsed, otherwise the fact that the participants have to wear some form of unnatural eye wear detracts from the realism of the experience.

There are a number of autostereoscopic display systems incorporating eye tracking that can be adapted for use with this teleconferencing system. For example, the present Applicants system described in Australian Patent No. 676733 (66718/94) the contents of which are hereby incorporated by reference. The present invention may also adapt the Applicants eye tracking system as described in Australian patent application number 13269/99 the contents of which are hereby incorporated by reference. However, it will be understood that other autostereoscopic display systems and eye or head tracking systems could also be adapted for use in this invention.

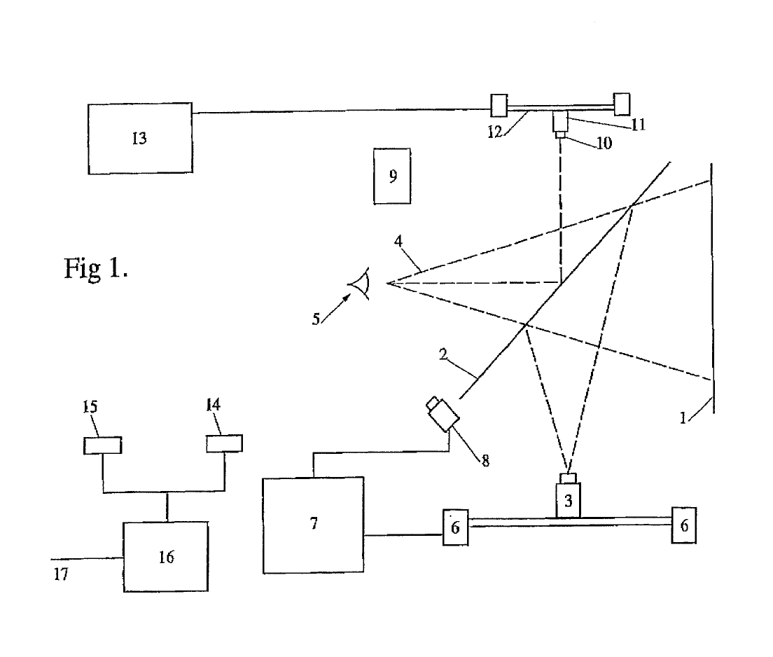

Referring now to FIG. 1, in a preferred embodiment the present invention includes a retroreflective screen (1) in front of which is located a 46° semireflective mirror (2), Situated below the mirror (2) are a pair of projectors (3) mounted such that the horizontal optical centres of the projectors are approximately spaced the interocular distance apart. The projectors (3) will preferably be video projectors using LOD, CRT, DLP or other technology. The projectors are focused on the retroreflective screen (1) so as to produce a stereo pair of exit pupils at position (4). Should a viewer (5) locate their eyes at position (4) then with suitable images fed to projectors (3) a 3D image will be observed.

The projectors (3) are mounted on a movable platform (6) (or other suitable means) that under control of servo system (7) (or other suitable means) enables them to be moved in an x, y and z direction under control of eye tracking system (8). In the preferred embodiment the eye tracking system would be as described in the Applicants patent application number 13269/99 and would incorporate an infrared illumination source (9).

Since the eye tracking system (8) is able to locate the viewers eyes in an x, y and z position, referenced to some datum, and via servo system (7) cause the projectors (3) to move such that the exit pupils (4) are incident upon the viewers eyes (5) an autostereoscopic display system is formed.

If now an additional pair of video cameras (10), with the horizontal distance between their optical axis set at approximately the interocular distance, is located above the mirror (2) a stereo pair of images (11) of the viewer (5) can be obtained via reflection from semi-reflective mirror (2).

The video cameras (10) are mounted on a movable platform (12) that under control of servo system (13) enables them to be moved in an x, y and z direction. Alternatively, instead of moving the cameras in the z direction the servo system may operate a power zoom lens attached to each camera and operated in unison.

It will be appreciated that the system could equany be configured with the projectors (3) located above the mirror (2), and the video cameras (10) located below the mirror (2), Similarly, the screen (1) could be located above or below the mirror (2) and either the projectors (3) or cameras (10) located behind the mirror (2).

Located adjacent to viewer (5) is a microphone (14) and loudspeaker (15) connected to a full duplex audio communications system (16) via communications medium (17).

To form a teleconferencing system a minimum of two such systems require to be connected via a communications medium. Each system will be located at different locations where viewers one and two respectively will be located. A plurality of video cameras arranged to image the first viewer are connected via the communications medium to the autostereoscopic display of the second viewer and visa versa. The video cameras are configured such that the viewer is able to look directly into the axis of the cameras. Thus each viewer can see the other in 3D. The output of the head or eye tracking system from the autostereoscopic display system used by the first viewer is connected via a communications medium to a servo system that moves the video cameras imaging the second viewer in sympathy with x and y axis movements of the first viewers head. Similarly, the output of the head tracking system from the autostereoscopic display system used by the second viewer is connected via a communications medium to a servo system that moves the video cameras imaging the first viewer in sympathy with x and y axis movements of the second viewers head.

Due to this configuration, as each viewer moves their head each sees a different perspective of the other viewer in a similar manner to viewing each other in real life.

In the present invention only two images of each party, a left and right image respectively, should require to be transferred between the viewing locations so as to minimise transmission bandwidth requirements. This improved bandwidth requirement alone provides a significant improvement over prior art systems.

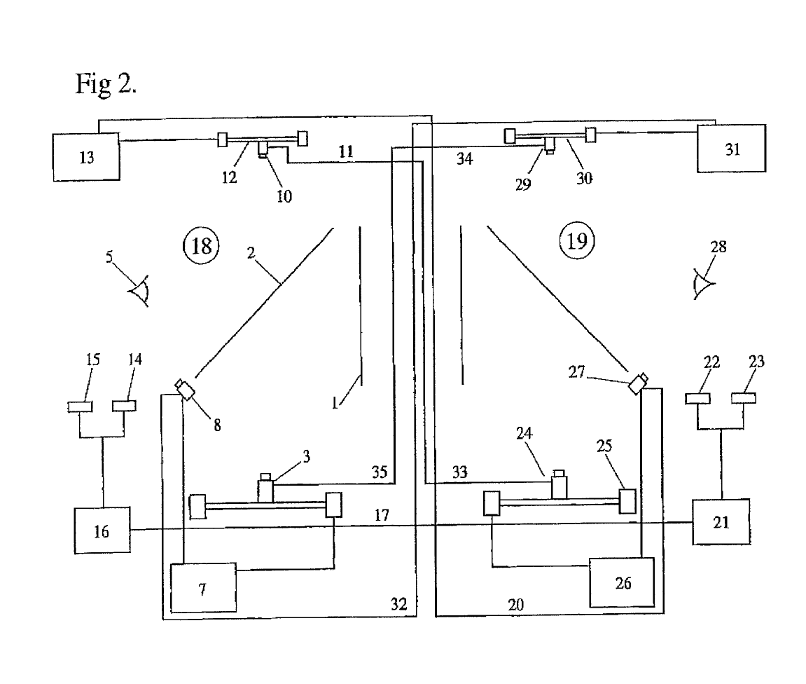

Referring now to FIG. 2, one method of connecting two systems as shown in FIG. 1 to form a teleconferencing system is shown.

In the preferred embodiment a remote system (19), which is configured identically to system (18), is connected to local system (18) as follows.

Video signals (11) from cameras (10) via communications medium (33) are connected to two video projectors (24). Similarly video signals (34) from cameras (29) are connected via communications medium (35) to video projectors (3).

Viewer (5) eye position information via eye tracker (8) and communications medium (32) is connected to servo system (31) so as to control cameras (29) via servo system (30). Similarly, viewer (28) eye position information via eye tracker (27) and communications medium (20) is connected to servo system (13) so as to control cameras (10) via servo system (12).

Full duplex audio system (16) is connected to full duplex audio system (21) via communications medium (17).

The communications mediums (17), (33), (20), (35), and (32) may be analogue or digital and may utilise any medium that will enable information to be transferred between the locations of the viewing systems such that any latency in transfer of information between the two locations is not objectionable to the viewers. Many communications media are suitable for this application and will be known to those skilled in the art. The signals transmitted by this media may be compressed in order to minimise bandwidth using suitable techniques known to those skilled in the art.

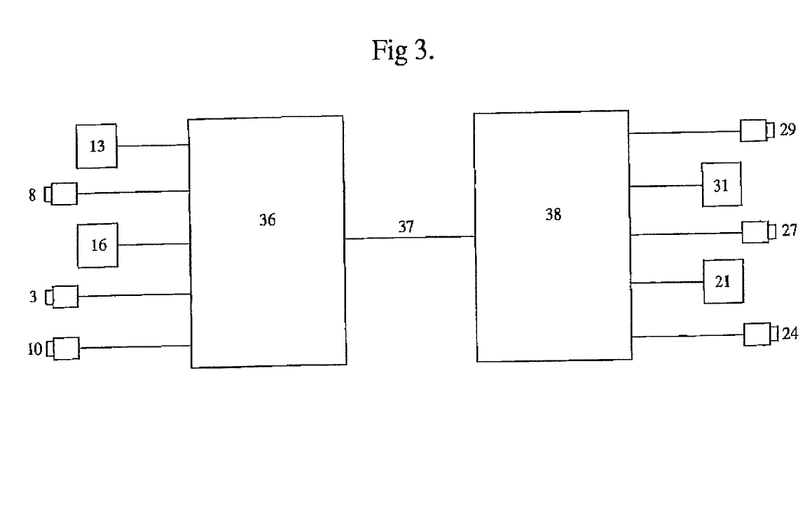

FIG. 3 shows how the interconnection between the systems (11) and (19) can be simplified. Rather than directly connecting the individual components of the system, the signals emanating from these components can be multiplexed over a full duplex communications system as shown in FIG. 3. Signals from system (18) are connected to multiplexer (36) via full duplex communications medium (37) to remote multiplexer (38). Suitable multiplexers will be known to those skilled in the art and may incorporate analogue or digital processing, time or frequency division multiplexing, as well as compression techniques to reduce the overall bandwidth requirements.

The communications medium (37) may be analog or digital and utilise any medium that will enable information to be transferred between the locations of the viewing systems such that any latency in transfer of information between the two locations is not objectionable to the viewers. Many communications media are suitable for this application and will be known to those skilled in the art.

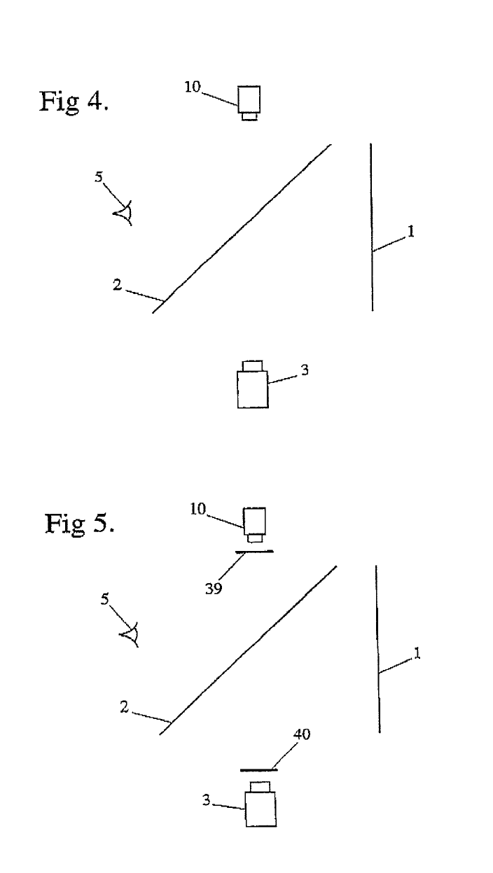

FIG. 4 serves to explain how a potential difficulty of this system can be over come. It has already been explained that video projectors (3) project onto semi-reflective mirror (2) onto retroreflective screen (1). Cameras (10) also use mirror (2) in order to image viewer (S). It will be appreciated that in practice light from projectors (3) will pass through mirror (2) and be seen by cameras (10). This is obviously undesirable and if such light is of sufficient level will render the system inoperative.

There are a number of ways to overcome this problem. If CRT based projectors are used for projectors (3) and CCD cameras used for cameras (10) then the period during which the ahutter of the camera is open can be synchronised with the frame fly back period of the projectors. In this situation there will be no image displayed on the projector that can be imaged by the cameras.

In practice, commercially available CRT projectors have a persistence of image such that even though an image may be removed from the CRT the afterglow associated with the phosphors an the screen of the CRT will continue to provide a low level image that will only decay over time. Low persistence CRTOs could be used which will assist with this problem,

Further improvements can be included it such a configuration is not considered practical for the particular application.

FIG. 5 shows one such method that can be used to overcome the weakness described with respect to FIG. 4. If orthogonally mounted polarisers (39) (40) are mounted over the lens of cameras (10) and projectors (3) then a substantial reduction in light appearing at cameras will be obtained. The polarisers (39) and (40) may be linear or circularly polarised and may incorporate Infrared filters if not already fitted to projectors and cameras. This configuration may be used in addition to timing the shutter opening of CCD cameras (10) with the frame blanking period of CRT projectors (3). This configuration will also enable other projector devices to be used other than those based upon CRTs. This may include, although not limited to, LCD, DMD, light valve etc.

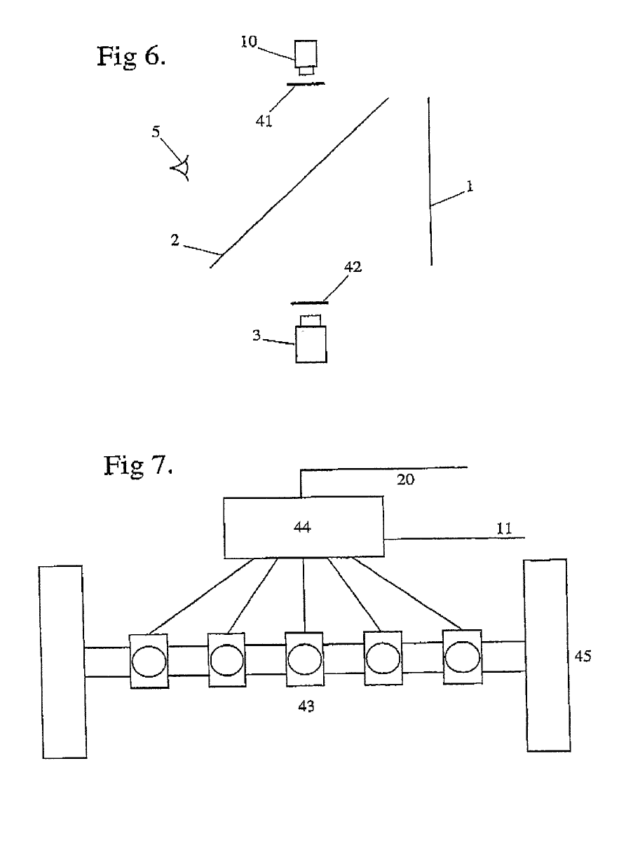

FIG. 6 shows another method that can be used to overcome this weakness. A shutter (42) is placed over the tenses of projectors (3). The shutter is closed during the period when the LCD shutter of cameras (10) is open. Since the shutter time of the cameras (10) is very fast the loss of image during this period is not noticeable to the viewer.

In order that any AGC (Automatic Gain Control) system incorporated in the cameras (10) are not activated during the time period that the shutter (42) is open, a second shutter (41) is placed in front of cameras (10) and operated in synchronism with shutter (42).

Whilst shutters (41) and (42) could be mechanical or electromechanical in nature, in a preferred embodiment they would be solid state in the form of LOD shutters, as for example those manufactured by Displaytech, Boulder, Colo., USA.

If necessary shutters (41) and (42) could be used in conjunction with polarisers (39) and (40).

FIG. 7 illustrates a method whereby movement of cameras (10) and (29) in the x direction can be eliminated. In this configuration a plurality of cameras (43) mounted in a horizontal plane, on movable platform (45), each with the axis of its lens separated the interocular distance apart and having their video outputs connected to a video selector (44). The output of the video selector (44) is selected by the eye tracker signal (20) from display system (19). As the viewer (28) moves their head the eye tracker signal (20) will enable the selection of the appropriate stereo pair of cameras (43) and thus provide an image perspective consistent with the location of viewer (28) head position. As previously described power zoom lenses could be attached to the array of cameras (43) so that movement in the z axis is not required.

It is desirable that cameras (43) should be mounted closer than the interocular distance. This is to provide a smooth transition between image pairs as the viewer moves their head.

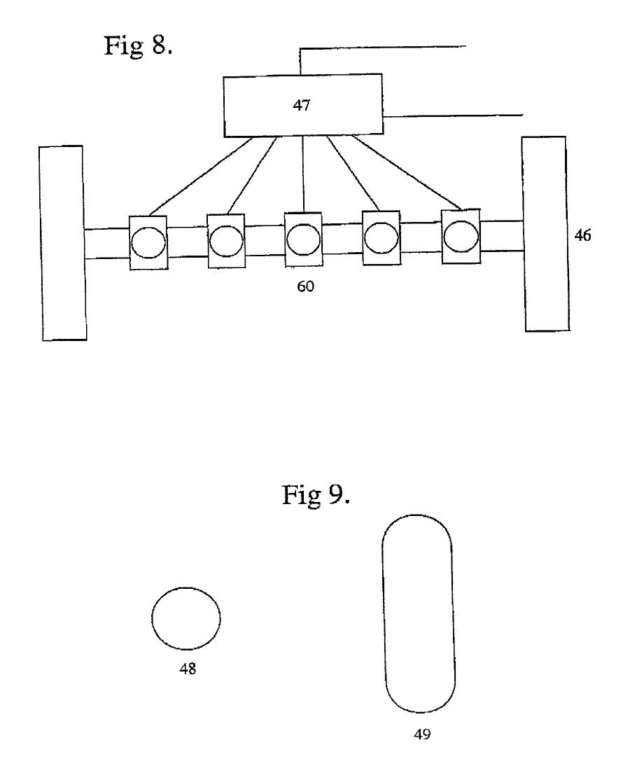

In a similar manner FIG. 8 shows how projectors (3) and (24) could be replaced with a plurality of projectors (60) mounted in a horizontal plane, on movable platform (46), each with the axis of its lens separated the interocular distance apart and having their video inputs connected to a video selector (47). The output of the video selector (47) is selected by monitoring te eye tracker signal (8) such that the relevant projector pair is activated in sympathy with the head movement of the viewer (5).

It is desirable that projectors (45) should be mounted closer than the interocular distance. This is to provide a smooth transition between image pairs as the viewer moves their head.

It is also possible to reduce or eliminate the need to track the viewers eyes as they move their head in the y direction by using an alternative lens at projectors (3) and (24). The exit pupil (4) seen by viewer (5) is shown in FIG. 9 at (48). Instead of using a projection lens that provides a circular exit pupil (48) a lens may be used that produces an elliptical exit pupil (49). Assuming the length of the elliptical exit pupil can be made sufficiently large, then the viewer (5) will have freedom of movement in the y axis without need for mechanical movement of the projectors (3) and (24). The production of elliptical exit pupils is known and in its simplest form may be constructed by grinding away the sides of a circular projection lens.

In some arrangements it may be preferable to include a plurality of cameras and a plurality of projectors. In such an arrangement the platform would then only be necessary to move in the y-axis. Further, if the projectors also had elliptical exit pupils then it would not be necessary to move the projectors platform at all.

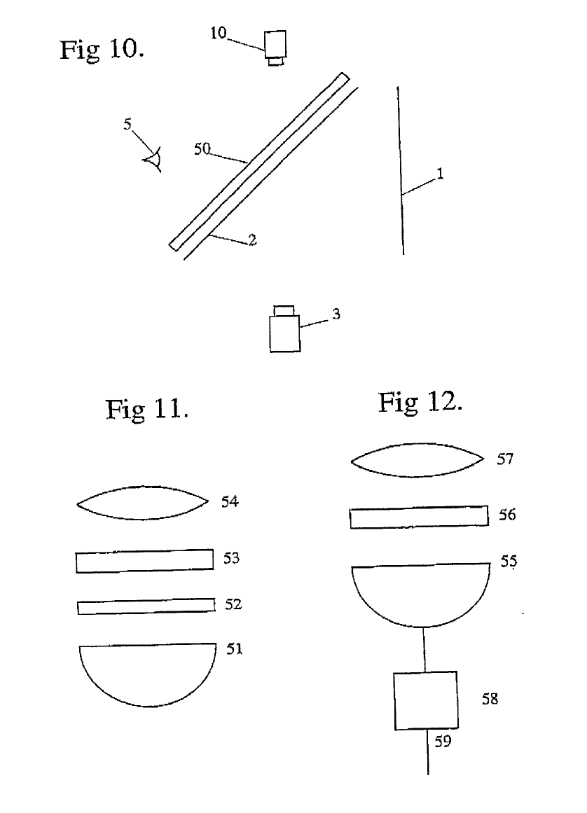

FIG. 10 illustrates an alternative method of preventing the camera (10) from imaging light from projector (3). A LCD shutter (50) is placed over the surface of semi-reflective mirror (2) and operated such that when the shutter of camera (10) is open the shutter is closed. Alternatively a sheet of solar control film as manufactured by 3M could be used.

FIG. 11 shows an alternative method of removing the projected image whilst the shutter of the camera (10) is open. The diagram shows the construction of a projector including an illumination source (51), image forming element (53) which for example may be a LCO element and projection lens (54). A switching element (52) is placed between the illumination source (51) and image forming element (53) so as to shutter the illumination source during the period that the shutter of camera (10) is open. The shutter may be electronic e.g. LCD, mechanical or electromechanical.

FIG. 12 shows a further alternative. The diagram shows the construction of a projector including an illumination source (55), image forming element (56) which for example may be a LCD element and projection lens (57). The illumination source may be turned off during the period that the shutter of camera (10) is open by means of switch (58) and control signal (59). A suitable illumination source (55) that can be switched sufficiently rapidly would be a Xenon lamp. Other suitable light sources will be known to those skilled in the art.

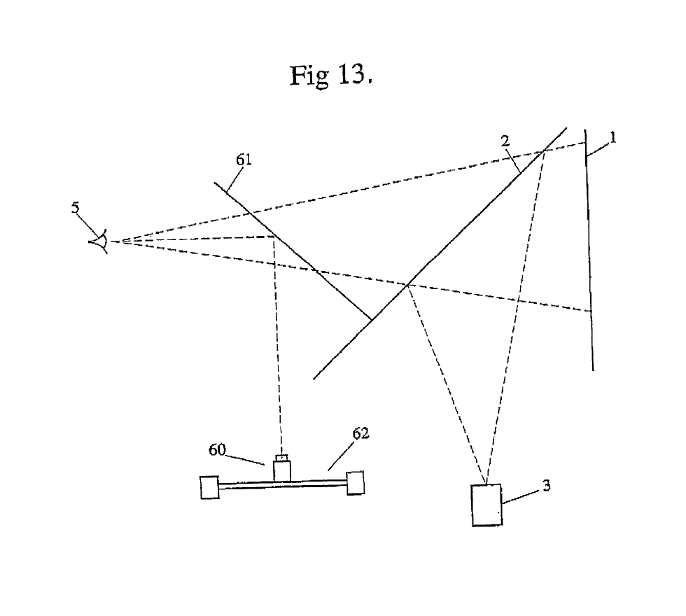

FIG. 13 shows an alternative configuration that overcomes the problem of the image from projectors (3) being imaged by the video cameras (10).

In this configuration, projectors (3) project onto semi-reflective mirror (2) via retroreflective screen (1) so as to form a stereoscopic exit pupil at the position of viewer (5). A second semi-reflective mirror (61) is positioned in front of the first semi-reflective screen and a plurality of projectors (60) mounted on movable carriage (62) positioned below the semi-reflective mirror (61). In this manner multiple images of the viewer (5) can be obtained for transmission to a similar configuration at a distant location.

The present invention enables a teleconferencing system to be installed which allows participants to see each other in 3D. Further, the system allows for the viewers to see different perspectives of each other and too also maintain eye contact if desired. However, it will be understood that modifications and variations such as would be apparent to a skilled addressee are considered within the scope of the present invention.

The claims defining the invention are as follows:

1. A local station for a teleconferencing system including:
a tracking means for locating the eyes and/or head of a local viewer;
said tracking means including an illumination means and a plurality of cameras for imaging the local viewer;
wherein said cameras are capable of being moved in the x, y and z directions in response to control signals from a remote station.

2. A local station for a teleconferencing system including:
a tracking means for locating the eyes and/or head of a local viewer;
a projection means adapted to project left and right eyes images from a remote station to respective left and right eyes of the local viewer;
a image capture means adapted to capture and transmit left and right eye images of the local viewer to the remote station;
wherein said projection means is movable in response to movements of the local viewer and wherein said image capture means is movable in response to control signals from the remote station.

3. A local station as claimed in claim 2, wherein said projection means includes a first projector and a second projector, and said image capture means includes a first camera and a second camera.

4. A local station for a teleconferencing system as claimed in any preceding claim, wherein said tracking means includes an illumination means to enable said tracking means to capture reflections from the local viewers eyes and/or head.

5. A local station as claimed in any preceding claim further including:
a retroreflective screen and a first semireflective mirror, wherein said screen and said first mirror are arranged to enable said projection means to focus images from the remote station onto the eyes of the local viewer, and for the image capture means to capture images of the local viewer for transmission to the remote station.

6. A local station as claimed in any preceding claim, wherein said control signals from the remote station correspond to movements of a remote viewer at the remote station.

7. A local station as claimed in any preceding claim, further including a microphone and a speaker; wherein said speaker enables the local viewer to hear sound from the remote station, and said microphone enables sound from the local station to be transmitted to the remote station.

8. A local station as claimed in any preceding claim, wherein said tracking means is adapted to track movements of the local viewer in the x, y and z directions.

9. A local station as claimed in any one of claims 5 to 8, wherein said screen is located in front of the local viewer and perpendicular to the local viewers line of sight, and said mirror is located between said local viewer and said screen at an angle of 45° relative to said screen.

10. A local station as claimed in claim 9, wherein said projection means is located below said mirror, and said image capture means is located above said mirror.

11. A local station as claimed in any one of claims 3 to 10, wherein said first and second projectors are LCD, CRT or DLP video projectors.

12 A local station as claimed in any one of claims 3 to 10, wherein said first and second projectors are CRT video projectors, and said first and second cameras are COD cameras; said local station further including a synchronising means to open the shutter of said first and second cameras during the frame fly back period of said first and second projectors.

13 A local station as claimed in any preceding claim further including a polarising means mounted over said projection means and said image capture means, to thereby reduce the amount of direct light captured by said image capture means from said projection means.

14 A local station as claimed in claim 13 wherein said polarising means are linearly or circularly polarised.

15 A local station as claimed in claim 13 or claim 14 wherein said potarising means further include infrared filters.

16 A local station as claimed in any one of claims 3 to 10, wherein said first and second cameras are LCD cameras; and wherein said local station further includes:
a first shutter means mounted over said projection means; and
a synchronislng means to close said first shutter means when the LCD shutter of said first and second cameras is open.

17 A local station as claimed in claim 16, further including a second shutter means over said image capture means, and synchronised with said first shutter means.

18 A local station as claimed in any one of claims 5 to 10, further including a LCD shutter placed over the surface of said mirror, and a synchronising means adapted to close said LCD shutter when the shutter of said image capture means is open, and to open said LCD shutter when the shutter of said image capture means is closed.

19 A local station as claimed in any one of claims 5 to 10, wherein said first and second projectors include a switching means able to be synchronised with said first and second cameras, such that said first and second projectors do not project any images onto said first mirror, when the shutter of said first and second cameras is open.

20 A local station as claimed in claim 19, wherein said switching means is adapted to switch of an illumination source of said first and second projectors, or form a barrier between said illumination source and an image forming element.

21 A local station as claimed in any one of claims 5 to 10, further including a second semireflective mirror, wherein said projection means projects images onto said first mirror and said image capture means captures reflected images of the viewer from said second mirror.

22. A local station as claimed in any one of claims 2 to 21, wherein said projection means is mounted on a first movable platform, said first movable platform being movable by a first servo system in response to output from said tracking means.

23. A local station as claimed in any one of claims 6 to 22, wherein said image capture means is mounted on a second movable platform, said second moveable platform being moved by a second servo system in response to movement of the remote viewer.

24 A local station as claimed in any one of claims 3 to 23, wherein said first and second camera are replaced by a plurality of cameras to negate the need for said image capture means to move in the x direction.

25 A local station as claimed in claim 24, wherein each said plurality of cameras is spaced apart such that the axis of each lens of said plurality of cameras is mounted equal to or less than the interocular distance.

26 A local station as claimed in any one of claims 3 to 25, wherein said first and second projectors are replaced by a plurality of projectors to negate the need for said projection means to move in the x direction.

27 A local station as claimed in claim 26, wherein each said plurality of projectors is spaced apart such that the axis of each lens of said plurality of projectors is mounted equal to or less than the interocular distance.

28 A local station as claimed in any one of claims 3 to 27, wherein said first and second projectors, or said plurality of projectors, include a lens adapted to produce an elliptical exit pupil, thereby negating the need to move said projection means in the y direction.

29 A local station as claimed in any one of claims 3 to 28, wherein said image capture means and/or said projection means include zoom capabilities to thereby negate the need to move said image capture means and/or said projection means in the z direction.

30 A local station as claimed in any one of claims 7 to 29, wherein said microphone and said speaker means is connected to a full duplex audio communications system.

31. A teleconferencing system including a local station and a remote station, wherein said local station is as claimed in any one of claims 1 to 30, and said remote station is identical to a local station as claimed in any one of claims 1 to 30.

32. A teleconferencing system as claimed in claim 31, wherein the local station projection means receives images of the remote viewer from the remote station image capture means, and the remote station projection means receives images of the local viewer from the local station image capture means.

33. A teleconferencing system as claimed in claim 31 or claim 32, wherein the local station image capture means moves in response to data received from the remote station tracking means, and the remote station image capture means moves in response to data received from the local station tracking means.

34 A local station substantially as hereinbefore described with reference to FIG. 1 of the accompanying drawings.

35. A teleconferencing system substantially as hereinbefore described with reference to the accompanying drawings.

36. A local station for a teleconferencing system including:
a tracking means for locating the eyes and/or head of a local viewer;
said tracking means including an illumination means and a plurality of cameras for imaging the local viewer;
wherein said cameras are capable of being moved in the x, y and z directions in response to control signals from a remote station.

37. A local station for a teleconferencing system as claimed in claim 36, wherein said tracking means includes an illumination means to enable said tracking means to capture reflections from the local viewers eyes and/or head.

38. A local station as claimed in claim 36 further including:
a retroreflective screen and a first semireflective mirror, wherein said screen and said first mirror are arranged to enable said projection means to focus images from the remote station onto the eyes of the local viewer, and for the image capture means to capture images of the local viewer for transmission to the remote station.

39. A local station as claimed in claim 36, wherein said control signals from the remote station correspond to movements of a remote viewer at the remote station.

40. A local station as claimed in claim 36, further including a microphone and a speaker; wherein said speaker enables the local viewer to hear sound from the remote station, and said microphone enables sound from the local station to be transmitted to the remote station.

41. A local station as claimed in claim 36, wherein said tracking means is adapted to track movements of the local viewer in the x, y and z directions.

42. A local station as claimed in claim 38, wherein said screen is located in front of the local viewer and perpendicular to the local viewers line of sight, and said mirror is located between said local viewer and said screen at an angle of 45° relative to said screen.

43. A local station as claimed in claim 39, wherein said screen is located in front of the local viewer and perpendicular to the local viewers line of sight, and said mirror is located between said local viewer and said screen at an angle of 45° relative to said screen.

44. A local station as claimed in claim 43, wherein said projection means is located below said mirror, and said image capture means is located above said mirror.

45. A local station as claimed in claim 36 further including a polarizing means mounted over said projection means and said image capture means, to thereby reduce the amount of direct light captured by said image capture means from said projection means.

46. A local station as claimed in claim 45 wherein said polarizing means are linearly or circularly polarized.

47. A local station as claimed in claim 45 wherein said polarizing means further include infrared filters.

48. A local station as claimed in claim 38, further including a LCD shutter placed over the surface of said mirror, and a synchronizing means adapted to close said LCD shutter when the shutter of said image capture means is open, and to open said LCD shutter when the shutter of said image capture means is closed.

49. A local station as claimed in claim 38, wherein said first and second projectors include a switching means able to be synchronized with said first and second cameras, such that said first and second projectors do not project any images onto said first mirror, when the shutter of said first and second cameras is open.

50. A local station as claimed in claim 49, wherein said switching means is adapted to switch of an illumination source of said first and second projectors, or form a barrier between said illumination source and an image forming element.

51. A local station as claimed in claim 38 further including a second semireflective mirror, wherein said projection means projects images onto said first mirror and said image capture means captures reflected images of the viewer from said second mirror.

52. A local station as claimed in claims 39, wherein said image capture means is mounted on a second movable platform, said second moveable platform being moved by a second servo system in response to movement of the remote viewer.

53. A local station as claimed in any one of claim 40, wherein said microphone and said speaker means is connected to a full duplex audio communications system.

54. A teleconferencing system including a local station and a remote station, wherein said local station is as claimed in claim 36, and said remote station is identical to a local station as claimed in claim 36.

55. A teleconferencing system as claimed in claim 36, wherein the local station image capture means moves in response to data received from the remote station tracking means, and the remote station image capture means moves in response to data received from the local station tracking means.

56. A local station for a teleconferencing system including:
a tracking means for locating the eyes and/or head of a local viewer;
a projection means adapted to project left and right eyes images from a remote station to respective left and right eyes of the local viewer;
a image capture means adapted to capture and transmit left and right eye images of the local viewer to the remote station;
wherein said projection means is movable in response to movements of the local viewer and wherein said image capture means is movable in response to control signals from the remote station.

57. A local station as claimed in claim 56, wherein said projection means includes a first projector and a second projector, and said image capture means includes a first camera and a second camera.

58. A local station for a teleconferencing system as claimed in claim 56, wherein said tracking means includes an illumination means to enable said tracking means to capture reflections from the local viewers eyes and/or head.

59. A local station as claimed in claim 56 further including:
a retroreflective screen and a first semireflective mirror, wherein said screen and said first mirror are arranged to enable said projection means to focus images from the remote station onto the eyes of the local viewer, and for the image capture means to capture images of the local viewer for transmission to the remote station.

60. A local station as claimed in claim 56, wherein said control signals from the remote station correspond to movements of a remote viewer at the remote station.

61. A local station as claimed in claim 56, further including a microphone and a speaker; wherein said speaker enables the local viewer to hear sound from the remote station, and said microphone enables sound from the local station to be transmitted to the remote station.

62. A local station as claimed in claim 56, wherein said tracking means is adapted to track movements of the local viewer in the x, y and z directions.

63. A local station as claimed in claim 59, wherein said screen is located in front of the local viewer and perpendicular to the local viewers line of sight, and said mirror is located between said local viewer and said screen at an angle of 45° relative to said screen.

64. A local station as claimed in claim 60, wherein said screen is located in front of the local viewer and perpendicular to the local viewers line of sight, and said mirror is located between said local viewer and said screen at an angle of 45° relative to said screen.

65. A local station as claimed in claim 63, wherein said projection means is located below said mirror, and said image capture means is located above said mirror.

66. A local station as claimed in claim 57, wherein said first and second projectors are LCD, CRT or DLP video projectors.

67. A local station as claimed in claim 57, wherein said first and second projectors are CRT video projectors, and said first and second cameras are CCD cameras; said local station further including a synchronising means to open the shutter of said first and second cameras during the frame fly back period of said first and second projectors.

68. A local station as claimed in claim 56 further including a polarising means mounted over said projection means and said image capture means, to thereby reduce the amount of direct light captured by said image capture means from said projection means.

69. A local station as claimed in claim 68 wherein said polarising means are linearly or circularly polarised.

70. A local station as claimed in claim 68 wherein said polarising means further include infrared filters.

71. A local station as claimed in claim 57, wherein said first and second cameras are LCD cameras; and wherein said local station further includes:
a first shutter means mounted over said projection means; and
a synchronising means to close said first shutter means when the LCD shutter of said first and second cameras is open.

72. A local station as claimed in claim 71, further including a second shutter means over said image capture means, and synchronised with said first shutter means.

73. A local station as claimed in claim 59, further including a LCD shutter placed over the surface of said mirror, and a synchronising means adapted to close said LCD shutter when the shutter of said image capture means is open, and to open said LCD shutter when the shutter of said image capture means is closed.

74. A local station as claimed in claim 59, wherein said first and second projectors include a switching means able to be synchronised with said first and second cameras, such that said first and second projectors do not project any images onto said first mirror, when the shutter of said first and second cameras is open.

75. A local station as claimed in claim 74, wherein said switching means is adapted to switch of an illumination source of said first and second projectors, or form a barrier between said illumination source and an image forming element.

76. A local station as claimed in of claim 59, further including a second semireflective mirror, wherein said projection means projects images onto said first mirror and said image capture means captures reflected images of the viewer from said second mirror.

77. A local station as claimed in claim 76, wherein said projection means is mounted on a first movable platform, said first movable platform being movable by a first servo system in response to output from said tracking means.

78. A local station as claimed in claim 60, wherein said image capture means is mounted on a second movable platform, said second moveable platform being moved by a second servo system in response to movement of the remote viewer.

79. A local station as claimed in claims 57, wherein said first and second camera are replaced by a plurality of cameras to negate the need for said image capture means to move in the x direction.

80. A local station as claimed in claim 79, wherein each said plurality of cameras is spaced apart such that the axis of each lens of said plurality of cameras is mounted equal to or less than the interocular distance.

81. A local station as claimed in claim 57, wherein said first and second projectors are replaced by a plurality of projectors to negate the need for said projection means to move in the x direction.

82. A local station as claimed in claim 81, wherein each said plurality of projectors is spaced apart such that the axis of each lens of said plurality of projectors is mounted equal to or less than the interocular distance.

83. A local station as claimed in claim 57, wherein said first and second projectors, or said plurality of projectors, include a lens adapted to produce an elliptical exit pupil, thereby negating the need to move said projection means in the y direction.

84. A local station as claimed in claim 57, wherein said image capture means and/or said projection means include zoom capabilities to thereby negate the need to move said image capture means and/or said projection means in the z direction.

85. A local station as claimed in claim 61, wherein said microphone and said speaker means is connected to a full duplex audio communications system.

86. A teleconferencing system including a local station and a remote station, wherein said local station is as claimed in claim 56, and said remote station is identical to a local station as claimed in claim 56.

87. A teleconferencing system as claimed in claim 86, wherein the local station projection means receives images of the remote viewer from the remote station image capture means, and the remote station projection means receives images of the local viewer from the local station image capture means.

88. A teleconferencing system as claimed in claim 86, wherein the local station image capture means moves in response to data received from the remote station tracking means, and the remote station image capture means moves in response to data received from the local station tracking means.

89. A teleconferencing system as claimed in claim 87, wherein the local station image capture means moves in response to data received from the remote station tracking means, and the remote station image capture means moves in response to data received from the local station tracking means.

90. A local station substantially as hereinbefore described with reference to FIG. 1 of the accompanying drawings.

91. A teleconferencing system substantially as hereinbefore described with reference to the accompanying drawings.
